(19) United States
(12) Patent Application Publication
(10) Pub. No.: US 2024/0066431 A1
(43) Pub. Date: Feb. 29, 2024

(54) MULTI-STAGE DESOLVENTIZATION OF OLEAGINOUS MATERIAL EXTRACTED WITH ALCOHOL SOLVENT

(71) Applicant: Crown Iron Works Company, Blaine, MN (US)

(72) Inventors: Nicholas Ollila, Fridley, MN (US); Wade Steven Martinson, Minneapolis, MN (US); Benjamin Wayne Floan, Andover, MN (US); Aaron Iwen, Mendota Heights, MN (US)

(21) Appl. No.: 18/455,180

(22) Filed: Aug. 24, 2023

Related U.S. Application Data
(60) Provisional application No. 63/400,748, filed on Aug. 24, 2022.

(51) Int. Cl. B01D 11/02

(52) U.S. Cl. CPC B01D 11/0288; B01D 11/023; B01D 11/0292

(57) ABSTRACT

Systems and techniques can be used to extract solid material with an alcohol-based solvent. To subsequently recover the solvent after extraction, the solvent-wet solid material having undergone extraction can be desolventized. The solvent-wet solid material may be desolventized in multiple stages, either in a single vessel or in multiple different vessels, to generate multiple corresponding condensate streams containing alcohol and water vaporized from the solvent-wet solid material. By splitting desolventization into multiple stages, the composition of the condensate streams generated during desolventization can be individually controlled to benefit downstream processing. For example, the first condensate stream produced during desolventization may have a comparatively low amount of water whereas a second condensate stream produced during desolventization may have a comparatively high amount of water. The first condensate stream may be recycled back to the extractor without further water removal whereas the second condensate stream may undergo additional processing to remove water.

### RELATED APPLICATION

This application claims priority to U.S. Provisional Patent Application No. 63/400,748, filed Aug. 24, 2022, the entire contents of which are incorporated herein by reference.

### TECHNICAL FIELD

This disclosure relates to solvent extraction and, more particularly to liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover oil from oil sands and other petroleum-rich materials. Typically, the petroleum-rich material is ground into small particles and then passed through an extractor to extract the oil from the solid material into a surrounding organic solvent.

During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock.

In practice, solvents such as hexane are typically used for extracting oil from oleaginous materials. The oil and/or extracted solid can be used as an intermediate or end product for human and/or animal consumption. While the solvent is removed from the oil and/or the extracted solid prior to consumption, consumers are increasingly sensitive about food production processes and standards. Ethanol is alternative solvent to hexane that can be used to separate oil from various oleaginous materials. Ethanol is GRAS (Generally Recognized As Safe), can be produced organically, including from renewable feedstocks, and is already accepted by the consuming public as a component of alcoholic beverages.

### SUMMARY

In general, this disclosure is directed to devices, systems, and techniques for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. Similarly, the concentration of oil in the solvent may increase as the solvent moves through the extractor from the solvent inlet to the solvent outlet.

The solid material having undergone extraction can discharge from the outlet of the extractor for further downstream processing. The solid material is typically solvent-wetted and carries residual solvent with the extracted solid material. As a result, the solvent-containing extracted solid material may be dried to recover the residual solvent for reuse and/or to provide a dried extracted solid material for further disposition. The residual solvent carried by the extracted solid material may include the alcohol (e.g., ethanol) used to extract oil from the solid material in the extractor and water. The water in the residual solvent carried by the extracted solid material may be water introduced with the fresh solvent into the extractor and/or water carried in with the fresh solid material introduced into the extractor.

The solvent-wetted solid material discharged from the extractor can be desolventized to dry the extracted solid material for further use and to recover the residual solvent for recycle and/or reuse. For example the solvent-wetted solid material may be heated to vaporize the solvent carried by the extracted solid material, thereby separating the solvent from the extracted solid material. The vaporized solvent can be condensed into a liquid for recovery and reuse.

In practice, the condensed solvent recovered through desolventization of the solvent-wetted solid material may contain an excess amount of water that necessitates separating water from the alcohol in the solvent before the alcohol and/or solvent can be reused in the extraction process. When using certain alcohols such as ethanol, however, an azeotropic mixture forms between the alcohol and water in the solvent. This makes separation of the excess water from the alcohol difficult and limits efficient recovery of the alcohol for reuse in the extraction process.

In accordance with some examples of the present disclosure, systems and techniques are described that recover alcohol from a solvent-wetted solid material having undergone extraction using multi-stage desolventization. For example, the solvent-wetted solid material discharged from the extractor may be desolventized in multiple stages, either in a single vessel or in multiple different vessels, to generate multiple corresponding vapor streams that are subsequently condensed into recovered condensate streams. Each condensate stream can comprise alcohol and water vaporized from the solvent-wetted solid material. The composition of the condensate streams generated during desolventization can be individually controlled to benefit downstream processing. This can allow more efficient and effective recovery of the alcohol for reuse in the extraction process as compared to desolventizing the solvent-wetted solid material and generating a single condensate stream for further processing.

For example, the applicant has identified that when vaporizing and condensing solvent from a solvent-wetted extracted solid material, the composition of the condensate can vary as the solvent-wetted extracted solid material dries from being solvent-wetted to comparatively dry. In some implementations, the concentration of water in the condensate generated from drying the solvent-wetted extracted solid material may be comparatively low when initially drying the solvent-wetted solid material but may increase as the solvent-wetted extracted solid material is further dried. As an example, the concentration of water in the condensate produced through heating of the solvent-wetted solid material may be comparatively low during initial drying (e.g., 2-3 wt % water) but may increase as the solvent-wetted solid material is further dried (e.g., 4-6 wt % water). For example, the concentration of water in the condensate produced while drying the solvent-wetted solid material may be at a comparatively low level until the solvent-wetted solid material reaches a threshold dryness level (e.g., alcohol level), at which point the concentration of water in the condensate may rapidly increase to a comparatively higher level.

In accordance with some implementations of the present disclosure, systems and techniques are described for desolventizing a solvent-wetted extracted material that involves generating multiple different condensate streams each having different concentrations of alcohol and water. For example, the solvent-wetted extracted material may be heated to produce a first vapor stream that is subsequently condensed to provide a first condensate that has a first concentration of water. The solvent-wetted extracted material may be further heated to produce a second vapor stream that is subsequently condensed to provide a second condensate strea that has a second concentration of water greater than the first concentration of water in the first condensate.

In some applications, the concentration of alcohol in the first condensate may be sufficiently high (and the first concentration of water sufficiently low) that the first condensate may be recycled back to and reintroduced into the extractor without performing further processing to remove water from the first condensate. The second condensate may be further processed to reduce the amount of water in the condensate, e.g., to a level suitable for recycling the stream back to the extractor. Since the second condensate necessarily has a lower volume than the combination of the first and second condensates together, the energy and processing requirements to reduce the water in the second condensate may be reduced as compared to generating a single condensate of greater volume that needs to be processed.

In one example, a method is described that includes extracting a material to be processed with a solvent comprising alcohol in an extractor to generate an extracted material stream and a miscella stream. The extracted material stream includes an extracted solid material wetted with liquid comprising alcohol and water. The method involves desolventizing the extracted material stream down to a first alcohol level thereby generating a partially desolventized extracted material and a first condensate, where the first condensate comprises water and the alcohol. The method further involves desolventizing the partially desolventized extracted material down to a second alcohol level less than the first alcohol level thereby generating a desolventized extracted material and a second condensate. The example specifies that the second condensate includes water and the alcohol and that a weight fraction of water in the second condensate is greater than a weight fraction of water in the first condensate.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extraction system according to the disclosure that includes multi-stage desolventization performed in multiple vessels.

FIG. 2 is a block diagram illustrating another example extraction system according to the disclosure that includes multi-stage desolventization performed in a single vessel.

FIG. 3 is an illustration of an example extractor configuration that can be used in the example systems of FIGS. 1 and 2.

FIG. 4 is a plot of experimental desolventization water concentration data.

### DETAILED DESCRIPTION

In general, this disclosure relates to liquid-solid extractor systems and processes that enable the extraction of one or more desired products from solid material flows. In some examples, the solid material is processed in a continuous flow extractor that conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

The solvent discharged from the extractor, which may be referred to as a miscella, contains extracted components (e.g., oil, carbohydrates, sugars) from the solid feedstock. The solvent-wet solid material discharged from the extractor may be residual solid feedstock having undergone extraction. In some configurations according to the present disclosure, systems and techniques are described for desolventizing the solvent-wet solid material discharged from the extractor. For example, the solvent-wet solid material may be desolventized in multiple stages, either in a single vessel or in multiple different vessels, to generate multiple corresponding condensate streams containing alcohol and water vaporized from the solvent-wet solid material. By splitting desolventization into multiple stages, the composition of the condensate streams generated during desolventization can be individually controlled to benefit downstream processing. For example, the first condensate stream produced during desolventization may have a comparatively low amount of water whereas a second condensate stream produced during desolventization may have a comparatively high amount of water. The first condensate stream may be recycled back to the extractor without further water removal whereas the second condensate stream may undergo additional processing to remove water.

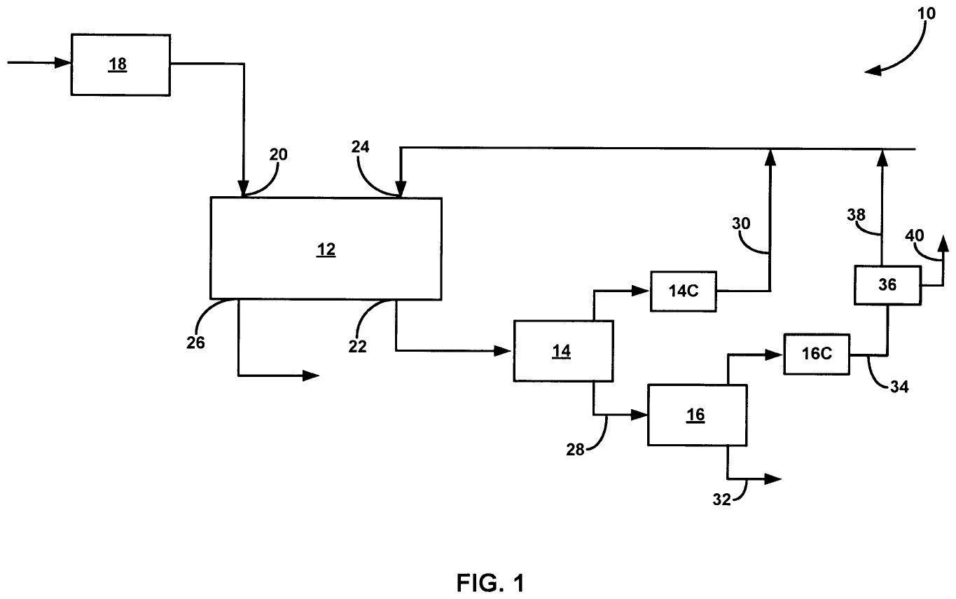

FIG. 1 is a block diagram illustrating an example extraction system 10 according to the disclosure. System 10 includes an extractor 12 and at least one desolventizing unit, which is illustrated as being implemented using a first desolventizing unit 14 and a second desolventizing unit 16 downstream of the first desolventizing unit. System 10 is also illustrated as including an optional dryer 18 upstream of extractor 12. Extractor 12 has a feed inlet 20 that can receive a solid material after having undergone drying in optional dryer 18 to be subject to extraction within the extractor. Extractor 12 also has a feed outlet 22 that can discharge the solid particulate material after is has undergone extraction and has a lower concentration of extract than the fresh incoming material. Extractor 12 also has a solvent inlet 24 configured to introduce fresh solvent into the extractor and a solvent outlet 26 configured to discharge a miscella formed via extraction of extractable components from the solid material.

In operation, the solid material being processed is contacted with solvent within extractor 12 (e.g., in co-current or counter current fashion), causing components soluble within the solvent to be extracted from the solid material into the solvent. Extractor 12 can process any desired solid material using any suitable extraction fluid. Example types of solid material that can be processed using extractor 12 include, but are not limited to, oleaginous matter, such as soybeans, rapeseed, sunflower seed, peanuts, cottonseed, palm kernels, and corn germ; oil-bearing seeds and fruits; asphalt-containing materials (e.g., asphalt-containing roofing shingles that include an aggregate material such as crushed mineral rock, asphalt, and a fiber reinforcing); alfalfa; almond hulls; anchovy meals; bark; coffee beans and/or grounds, carrots; chicken parts; diatomic pellets; fish meal; hops; oats; pine needles; tar sands; vanilla; and wood chips and/or pulp.

Alcohol-based solvents that can be used for extraction from solid material include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent supplied to solvent inlet 24 of extractor 12 has greater than 90 weight percent alcohol and less than 10 weight percent water, such as greater than 95 weight percent alcohol and less than 5 weight percent water, or greater than 98 weight percent alcohol and less than 5 weight percent water. In some examples, the solvent includes alcohol and water that form an azeotropic mixture having the same concentration of alcohol and water in both the liquid and vapor phases, preventing separation via distillation.

In some implementations, the solid material supplied to extractor 12 is dried by dryer 18 before being extracted in extractor 12. Dryer 18 can reduce the amount of water in the solid material supplied to extractor 12. When using an alcohol-based solvent, the water content of the solid material introduced into the extractor may be controlled to prevent excess water from entering the extractor, which can dilute the solvent (e.g., reducing the effectiveness of the extraction and/or making solvent recovery challenging).

In the example of FIG. 1, extraction system 10 includes a dryer 18 to dry the solid feed material before the material is introduced into extractor 12. Dryer 18 may dry the material before and/or after size reduction and/or after other preprocessing (when performed) and, in different implementations, dryer 18 may be an indirect dryer and/or a direct dryer. For example, dryer 18 may indirectly dry the solid material, e.g., by passing a thermal transfer fluid through a jacketed drying vessel. Additionally or alternatively, dryer 18 may directly dry the solid material, e.g., by introducing a hot gas (e.g., dried air, nitrogen) into the solid material to pick up moisture and then vent the gas out of the vessel.

In general, dryer 18 may dry the solid material at a temperature effective to vaporize at least a portion of the moisture present in the material but also at a temperature not so hot as to damage the solid material (e.g., change the structure and/or degrade the nutritive properties of the material). In some implementations, dryer 18 dries the solid material at a temperature greater than 30° C., such as greater than 50° C., or greater than 60° C., greater than 70° C., greater than 80° C., or greater than 100° C. Additionally or alternatively, dryer 18 may dry the solid material at a temperature less than 125° C., such as less than 100° C., or less than 80° C. For example, dryer 18 may dry the solid material at a temperature below the boiling point of water. In some examples, dryer 18 may dry the solid material at a temperature ranging from 40° C. to 90° C., such as from 50° C. to 80° C. Dryer 18 may typically operate at atmospheric pressure although, in other examples, may be configured to operate at a non-atmospheric pressure (e.g., vacuum pressure, positive pressure).

When used, dryer 18 can reduce the moisture content of the solid material. In some examples, dryer 18 is configured to dry the solid material to be processed to a moisture content of 5 weight percent or less, such as 3 weight percent or less, or 2 weight percent or less. Depending on the moisture content of the incoming solid material, dryer 18 may reduce the moisture content of the solid material by at least 0.5 weight percent, such as by at least one weight percent, by at least two weight percent, by at least three weight percent, by at least four weight percent, or by at least five weight percent.

Extractor 12 can produce a solvent-wet solids stream that discharges through feed outlet 22 and a miscella stream that discharges through solvent outlet 26. The miscella stream may be further processed separate the solvent from the oil. Example systems and techniques for separating the solvent from the oil in the miscella stream are described in PCT Patent Application No. PCT/US22/17965 titled “Alcohol Solvent Recovery for Oleaginous Material Extraction” filed Feb. 25, 2022, and PCT Publication No. WO 2022/006165 titled “Oleaginous Material Extraction Using Alcohol Solvent” filed Jun. 29, 2021, the entire contents of each of which are incorporated herein by reference.

To recover solvent from the solvent-wet extracted solids steam and further prepare the residual extracted solids material for end use, the solvent-wet extracted solids stream may be desolventized by heating the solvent-wet extracted solids steam to vaporize solvent from the extracted solids stream. The vapor generated by heating the solvent-wet extracted solids steam can subsequently be condensed to produce a liquid comprising alcohol and water recovered from the solvent-wet extracted solids steam. In accordance with some implementations of the present application, the solvent-wet extracted solids stream may be desolventized to generate multiple different condensate streams each having a different concentration of water and alcohol. This can allow differential downstream processing and use of the resulting condensate streams in extraction system 10.

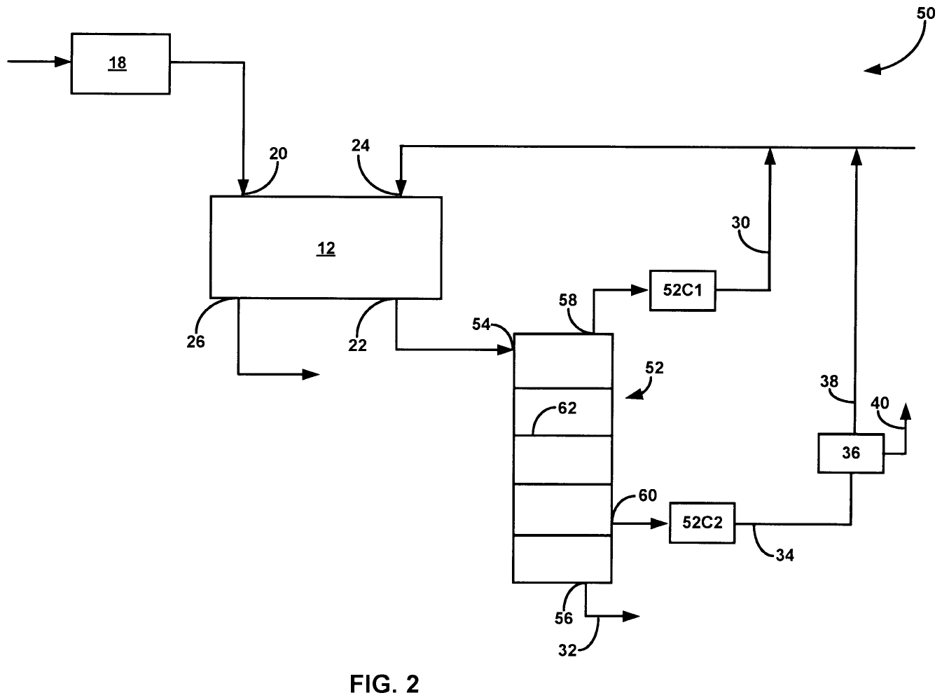

In the example of FIG. 1, extraction system 10 is illustrated as being implemented with a first desolventizer unit 14 and a second desolventizer unit 16 downstream of the first desolventizer. In different applications, extraction system 10 may utilize a single desolventizer unit (e.g., as discussed in conjunction with FIG. 2) or a larger number of desolventizer units (e.g., three, four, or more) without departing from the scope of the disclosure. In the example of FIG. 1, however, solvent-wetted extracted solid material (also referred to as “extracted solid material”) having undergone extraction in extractor 12 discharges from feed outlet 22 of extractor 12. The extracted material can be received by first desolventizer unit 14 and desolventized down to a first alcohol level, thereby generating a partially desolventized extracted material 28 and a first vapor stream that is condensed in a first condenser 14C to provide a first condensate 30.

In the example of FIG. 1, the partially desolventized extracted material 28 can discharge from first desolventizer unit 14 and be received by second desolventizer unit 16. Second desolventizer unit 16 can desolventize the partially desolventized extracted material 28 down to a second alcohol level less than the first alcohol level, thereby generating a desolventized extracted material 32 and a second vapor stream that is condensed in a second condenser 16C to provide a second condensate 34. The first condensate 30 and the second condensate 34 can each include water and alcohol recovered from the solvent-wet extracted solids material, with the concentration of water being greater in the second condensate 34 than the first condensate 30. That is, a weight fraction of water in the second condensate may be greater than a weight fraction of water in the first condensate.

In practice, the incoming solvent-wetted extracted solid material supplied to first desolventization unit 14 from extractor 12 may be greater than 20 weight percent solvent (e.g., alcohol and water) based on total weight of the solvent-wetted extracted solid material (e.g., combined weight of the extracted solid material and the weight of the liquid wetting the solid material). For example, the concentration of solvent in the incoming solvent-wetted extracted solid material may be greater than 25 weight percent based on the total weight of the solvent-wetted extracted solid material, such as greater than 30 weight percent, greater than 35 weight percent, or greater than 45 weight percent. In some applications, the concentration of solvent in the incoming solvent-wetted solid material supplied to first desolventizer unit 14 may range from 15 weight percent to 50 weight percent based on the total weight of the solvent-wetted solid material, such as from 30 weight percent to 50 weight percent, or from 35 weight percent to 45 weight percent. The concentration of the solvent wetting the extracted solid material may be within any of the ranges discussed above with respect to example alcohol-based solvent concentrations. In some implementations, the solvent-wetted extracted solid material from extractor 12 may undergo one or more preliminary steps of thermal and/or mechanical desolventizing before being received by first desolventizing unit 14 for further desolventizing.

First desolventizing unit 14 can receive the solvent-wetted extracted solid material and vaporize a portion of the solvent from the extracted solid material, thereby reducing the concentration of alcohol (as well as water) in the extracted solid material down to a first alcohol level, which may also be referred to as a first alcohol concentration. This can generate the partially desolventized extracted material 28 having the first alcohol level that is discharged from the first desolventizing unit 14 for further processing. For example, first desolventizing unit 14 may vaporize an amount of alcohol from the incoming solvent-wetted extracted solid material received (directly or indirectly) from extractor 12 effective to produce partially desolventized extracted material 28 having a first alcohol level less than 20 weight percent based on the total weight of the partially desolventized extracted material, such as less than 15 weight percent, less than 12 weight percent, less than 10 weight percent, less than 8 weight percent, or less than 6 weight percent.

While first desolventizing unit 14 may vaporize a portion of the alcohol from the incoming solvent-wetted extracted solid material received from extractor 12, the amount of alcohol removed from the solvent-wetted extracted solid material in first desolventizing unit 14 may be limited to prevent excess water carryover with the vaporized alcohol into the first condensate 30. For example, the first desolventizing unit 14 may vaporize an amount of alcohol from the incoming solvent-wetted extracted solid material effective to produce partially desolventized extracted material 28 having a first alcohol level greater than 3 weight percent based on the total weight of the partially desolventized extracted material, such as greater than 4 weight percent, greater than 5 weight percent, or greater than 6 weight percent. For example, the first desolventizing unit 14 may vaporize an amount of alcohol from the incoming solvent-wetted extracted solid material effective to produce partially desolventized extracted material 28 having a first alcohol level ranging from 5 weight percent to 15 weight percent based on the total weight of the partially desolventized extracted material, such as from 5 weight percent to 10 weight percent. The amount of alcohol vaporized from the solvent-wetted extracted solid material supplied to first desolventizing unit 14 may be controlled, e.g., by controlling the sizing and residence time of the material being processed in the first desolventizing unit 14 and/or the operating temperature and/or pressure inside of the unit.

The solvent vaporized from the solvent-wetted extracted solid material in first desolventizing unit 14 to produce the partially desolventized extracted material 28 can be condensed in condenser 14C operatively connected to the first desolventizing unit. This can produce a first condensate stream 30, which can be a complete condensation of the vapor produced by the first desolventizing unit 14 or a partial condensation of the vapor produced by the unit (e.g., providing a mixed vapor-liquid phase). By controlling the extent to which the solvent-wetted extracted solid material is desolventized in first desolventizing unit 14, the composition of first condensate 30 can be controlled. In particular, the relative amounts of water and alcohol in the first condensate 30 may be controlled to provide a condensate containing a comparatively limited amount of water.

In various applications, the concentration of alcohol in the first condensate 30 is at least 90 weight percent alcohol based on the total weight of the condensate (e.g., including the combined weight of alcohol and water forming the condensate), such as greater than 92 weight percent alcohol, greater than 94 weight percent alcohol, greater than 95 weight percent alcohol, greater than 96 weight percent alcohol, greater than 97 weight percent alcohol, greater than 97.5 weight percent alcohol, greater than 98 weight percent alcohol, greater than 98.5 weight percent alcohol, or greater than 99 weight percent alcohol. The remaining weight of the first condensate 30 may be substantially or entirely water vaporized with the alcohol from the solvent-wetted extracted solid material. Accordingly, the weight fraction of water in the first condensate 30, which may be reported as a percentage, may be less than 8 weight percent water based on the total weight of the condensate (e.g., including the combined weight of alcohol and water forming the condensate), such as less than 6 weight percent water, less than 5 weight percent water, less than 4 weight percent water, less than 3 weight percent water, less than 2.5 weight percent water, less than 2 weight percent water, less than 1.5 weight percent water, or less than 1 weight percent water. For example, the first condensate 30 may have a concentration of greater than 90 weight percent alcohol and less than 10 weight percent water based on the total weight of the condensate, such as greater than 95 weight percent alcohol and less than 5 weight percent water, or greater than 98 weight percent alcohol and less than 2 weight percent water.

In the example of FIG. 1, second desolventizing unit 16 receives the partially desolventized extracted material 28 initially desolventized in first desolventizing unit 14 that carries residual solvent (e.g., alcohol and water). Second desolventizing unit 16 can receive the partially desolventized extracted material 28 and vaporize a portion of the remaining solvent from the partially desolventized extracted material, thereby reducing the concentration of alcohol (as well as water) in the partially desolventized extracted solid material down to a second alcohol level, which may also be referred to as a second alcohol concentration. This can generate the desolventized extracted material 32 having the second alcohol level that is discharged from the second desolventizing unit 16 for further processing or disposition. It should be appreciated that reference to a dried and/or desolventized solid material refers to a material that is comparatively dried and desolventized and does not require complete drying or desolventization or that the material be devoid of solvent.

For example, second desolventizing unit 16 may vaporize an amount of alcohol from the partially desolventized extracted material 28 effective to produce desolventized extracted material 32 having a second alcohol level less than 15 weight percent based on the total weight of the desolventized extracted material (e.g., combined weight of the extracted solid material and the weight of the remaining liquid wetting the solid material), such as less than 10 weight percent, less than 8 weight percent, less than 5 weight percent, less than 3 weight percent, less than 2 weight percent, or less than 1 weight percent. For example, the second desolventizing unit 16 may vaporize an amount of alcohol from the partially desolventized extracted material 28 effective to produce desolventized extracted material 32 having a second alcohol level 0.5 weight percent (5000 ppm), such as less than 0.1 weight percent (1000 ppm). In general, partially desolventized extracted material 28 may be desolventized to a level suitable for the intended subsequent use and/or disposition of the resulting desolventized extracted material 32. The amount of alcohol vaporized from the partially desolventized extracted material 28 may be controlled, e.g., by controlling the sizing and residence time of the material being processed in the second desolventizing unit 16 and/or the operating temperature and/or pressure inside of the unit.

The solvent vaporized from the partially desolventized extracted material 28 in second desolventizing unit 16 to produce the desolventized extracted material 32 can be condensed in condenser 16C operatively connected to the second desolventizing unit. This can produce a second condensate stream 34, which can be a complete condensation of the vapor produced by the second desolventizing unit 16 or a partial condensation of the vapor produced by the unit (e.g., providing a mixed vapor-liquid phase). In general, the concentration of alcohol in second condensate 34 can be less than the concentration of alcohol in first condensate 30, and the concentration of water in the second condensate can be greater than the concentration of water in the first condensate.

Without wishing to be bound by any particular theory, applicant has observed that free water intermixed with alcohol forming the solvent wetting the solid material being desolventized initially vaporizes with the amount of water vaporizing proportional to the amount of alcohol vaporizing during desolventization. This can allow the formation of a first condensate having a comparatively low amount of water. As the solid material being desolventized continues to be heated, water chemically bound with the solid material being desolventized begins releasing into the vapor, causing the concentration of water in the condensate to increase. By segregating the condensate formed during desolventization into different streams as drying of the solid material progresses, the condensate with the lower water concentration can be segregated from the condensate with the higher water concentration to benefit downstream reuse and/or further processing.

In various applications, the weight fraction of water in the second condensate 34, which may be reported as a percentage, may be greater than 2 weight percent water based on the total weight of the condensate (e.g., including the combined weight of alcohol and water forming the condensate), such as greater than 3 weight percent water, greater than 3.5 weight percent water, greater than 4 weight percent water, greater than 4.5 weight percent water, greater than 5 weight percent water, greater than 5.5 weight percent water, greater than 6 weight percent water, greater than 6.5 weight percent water, greater than 7 weight percent water, greater than 8 weight percent water, greater than 9 weight percent water, or greater than 10 weight percent water. The amount of water present in the second condensate 34 can be limited, e.g., by the amount of water present in the partially desolventized extracted material 28 to be vaporized. Accordingly, in combination with any one of the foregoing lower water concentration values, the weight fraction of water in the second condensate 34 may be within a range bounded by an upper limit of less than 30 weight percent water based on the total weight of the condensate, such as less than 25 weight percent water, less than 20 weight percent water, less than 15 weight percent water, less than 10 weight percent water, less than 9 weight percent water, less than 8 weight percent water, less than 7 weight percent water, less than 6 weight percent water, or less than 5 weight percent water.

The remaining weight of the second condensate 34 may be substantially or entirely alcohol vaporized with the water from the solvent-wetted extracted solid material. Accordingly, the concentration of alcohol in the second condensate 34 may be greater than 70 weight percent alcohol based on the total weight of the condensate, such as greater than 75 weight percent alcohol, greater than 80 weight percent alcohol, greater than 85 weight percent alcohol, greater than 90 weight percent alcohol, greater than 91 weight percent alcohol, greater than 92 weight percent alcohol, greater than 93 weight percent alcohol, greater than 94 weight percent alcohol, or greater than 95 weight percent alcohol. The amount of alcohol present in the second condensate 34 can be limited, e.g., by the amount of water present in the condensate. Accordingly, in combination with any one of the foregoing lower alcohol concentration values, the concentration of alcohol in the second condensate 34 may be within a range bounded by an upper limit of less than 98 weight percent alcohol based on the total weight of the condensate, such as less than 97 weight percent alcohol, less than 96.5 weight percent alcohol, less than 96 weight percent alcohol, less than 95.5 weight percent alcohol, less than 95 weight percent alcohol, less than 94.5 weight percent alcohol, less than 94 weight percent alcohol, less than 93 weight percent alcohol, less than 92 weight percent alcohol, less than 91 weight percent alcohol, or less than 90 weight percent alcohol.

If injecting steam (e.g., sparge steam) in second desolventizing unit 16, the weight fraction of water in the second condensate 34 may be greater (and the weight fraction of alcohol in the second condensate correspondingly lower) than the foregoing values and ranges. In some examples, the weight fraction of water in the second condensate 34 may be greater than 30 weight percent water based on the total weight of the condensate (e.g., including the combined weight of alcohol and water forming the condensate), such as greater than 40 weight percent water, greater than 50 weight percent water, greater than 60 weight percent water, or greater than 70 weight percent water. For example, the weight fraction of water in the second condensate 34 may range from 30 weight percent water based on the total weight of the condensate to 80 weight percent, such as from 40 weight percent to 75 weight percent, or from 50 weight percent to 70 weight percent. The remaining weight of the second condensate 34 in each of the foregoing examples may be substantially or entirely alcohol vaporized with the water from the solvent-wetted extracted solid material. Accordingly, the second condensate 34 may have corresponding alcohol weight fractions for any for the foregoing examples calculated by subtracting the recited water weight percent from 100.

By segregating the solvent vaporized from the solvent-wetted extracted solid material into different condensate streams, the amount of water in each condensate stream can vary. For example, a difference in the concentration of water in the second condensate 34 compared to the concentration of water in the first condensate 30 (e.g., weight fraction of water in second condensate 34 minus weight fraction of water in first condensate 30, which may be reported as a percentage) may be within a range from 1% to 15%, such as from 2% to 10%, or from 3% to 5%. Even small differences in the amount of water in one condensate stream compared to another condensate stream may be impactful in commercial operation, e.g., where the condensate with a lower amount of water requires little or no further processing to remove excess water before being reused.

Each feature described as a desolventizing unit, including first desolventizing unit 14 and second desolventizing unit 16 can be implemented using one or more stages of thermal treatment, optionally in combination with mechanical treatment, to remove solvent from the extracted solid material being processed. Each desolventizing unit can include a vessel that receives the extracted solid material to be desolventized and introduces thermal energy to the extracted solid material to be desolventized in the vessel. In different examples, each desolventizing unit can operate at positive pressure, atmospheric pressure, or vacuum pressure.

Each desolventizing unit can directly and/or indirectly heat the extracted solid material to be desolventized. The desolventizing unit may indirectly heat the extracted solid material by passing a heat transfer fluid through a tray that the extracted material contacts while passing through a desolventizing vessel and/or through a jacket surrounding at least a portion of the desolventizing vessel. Additionally or alternatively, the desolventizing unit may introduce a heated gas substantially devoid of moisture (e.g., dried air, nitrogen) into an interior of the desolventizing vessel and the extracted solid material therein. Still further additionally or alternatively, the desolventizing unit may introduce steam into an interior of the desolventizing vessel and the extracted solid material therein.

In some implementations, one or both of first desolventizing unit 14 and second desolventizing unit 16 are configured to operate without adding moisture to the extracted solid material being desolventized in the desolventizing unit. For example, one or both of first desolventizing unit 14 and second desolventizing unit 16 may operate without injecting steam into the extracted solid material being desolventized in the desolventizing unit. Implementing one or both of first desolventizing unit 14 and second desolventizing unit 16 to operate without injecting steam or other added water to the extracted solid material being desolventized can be beneficial to minimize the amount of water added to the system that may subsequently need to be separated from the alcohol to recover the alcohol for reuse in extractor 12.

In some implementations, however, steam may be injected in one but not both of first desolventizing unit 14 and second desolventizing unit 16. For example, first desolventizing unit 14 may be configured to operate without introducing steam or other added water to the extracted solid material being desolventized in the unit. By contrast, second desolventizing unit 16 may be configured to operate with steam injection in which steam is injected into the partially desolventized extracted material 28 introduced into the second desolventizing unit. In such implementations, processing the solvent-wetted extracted solid material in first desolventizing unit 14 in the absence of added steam can be beneficial to achieve a high alcohol concentration first condensate 30, e.g., which may be recycled back to extractor 12 with limited or no further water removal. In contrast, processing the partially desolventized extracted material 28 in second desolventizing unit 16 with added steam can promote efficient the desolventizing and generation of the desolventized extracted material 32. While the added steam may further dilute the concentration of alcohol in second condensate 34 (e.g., as compared to operating second desolventizing unit 16 in the absence of added steam), the second condensate may be further processed to remove excess water under either operating condition, and the additional steam added to the process may therefore not significantly change downstream processing.

First desolventizing unit 14 can operate under a first set of vaporization conditions, and second desolventizing unit 16 can operate under a second set of vaporization conditions. The vaporization conditions may be a set of processing parameters that dictate the extent to which solvent is vaporized from the extracted solid material being processed in each respective desolventizing unit and, correspondingly, the composition of the resulting condensate produced by the desolventizing unit. For example, the vaporization conditions of either desolventizing unit may be dictated, at least in part, by the operating temperature and/or temperature profile of the unit, operating pressure, and heat transfer configuration of the unit (e.g., direct and/indirect heat transfer, addition and/or absence of steam injection).

In some applications, the second set of vaporization conditions under which second desolventizing unit 16 operates is the same as the first set of vaporization conditions under which first desolventizing unit 14 operates. In these applications, desolventization of the extracted solid material may be split between the different desolventizing units to facilitate generation of different condensate streams having different compositions but otherwise processed under substantially the same conditions in each desolventizing unit. In other applications, however, the second set of vaporization conditions under which second desolventizing unit 16 operates is different than the first set of vaporization conditions under which first desolventizing unit 14 operates. For example, second desolventizing unit 16 may operate at a different temperature (e.g., higher temperature), a different pressure, and/or different thermal transfer conditions (e.g., addition of steam) then first desolventizing unit 14.

A desolventizing unit according to the disclosure can be implemented in practice using a variety of different processing units. In different examples, a desolventizing unit can be implemented using a cooker, jacketed paddle mixer, a bulk solids heat exchanger, a desolventizer-toaster, a rotary disk dryer, a down-draft desolventizer, and/or a flash dryer. In applications where multiple desolventizing units are utilized, each desolventizing unit may be implemented using the same type of process equipment, or one desolventizing unit may be implemented using a different type of process equipment than another desolventizing unit. In some examples, first desolventizing unit 14 is implemented using a rotary disk dryer, a desolventizer-toaster, a down-draft desolventizer, a flash dryer, or combinations thereof. In these examples, second desolventizing 16 may be implemented using a desolventizer-toaster, a down-draft desolventizer, a flash dryer, or combinations thereof.

In some examples, the first condensate 30 generated by first desolventizing unit 14 and the second condensate 34 generated by second desolventizing unit 16 each provide a recovered solvent (e.g., alcohol) that is reused in extraction system 10. For example, the first condensate 30 generated by first desolventizing unit 14 and the second condensate 34 generated by second desolventizing unit 16 may provide a recovered solvent that is recycled back to solvent inlet 24 of extractor 12 for reuse in the extraction of additional incoming solid material entering through feed inlet 20 of the extractor.

First condensate 30 and second condensate 34 may or may not undergo additional processing before being recycled back to extractor 12. For example, first condensate 30 and/or second condensate 34 may be filtered to reduce the amount of particulate present in the condensate before returning to extractor 12. In some examples, first condensate 30 and/or second condensate 34 is processed to reduce the amount of water present in the condensate, thereby increasing the alcohol concentration in the condensate to a level suitable for returning the condensate as an incoming solvent stream to solvent inlet 24 of extractor 12 and/or other desired downstream use.

First condensate 30 and/or second condensate 34 may be processed using a variety of different techniques to remove water from the condensate. As discussed above, when using an alcohol solvent such as ethanol, the water and alcohol may form an azeotropic mixture that is challenging to separate for solvent recovery. In these applications, the water cannot be readily removed from the alcohol based on differential vapor pressure using distillation or other thermal separation processes. In these and other applications, water may be removed from the condensate to increase the alcohol concentration in the condensate using non-thermal separation techniques, such as adsorption and/or membrane separation processes.

While one or both of first condensate 30 and second condensate 34 can be processed to remove water from the condensate, thereby providing a high alcohol concentration solvent for recycle and/or reuse, in some implementations, first condensate 30 is recycled back to extractor 12 without further water removal and second condensate 34 is further processed to remove water before being recycled back to the extractor. For example, first condensate 30 generated by first desolventizing unit 14 may be recycled back to solvent inlet 24 of extractor 12 without processing the condensate to reduce the water concentration in the condensate before reintroducing into the extractor. By contrast, second condensate 34 generated by second desolventizing unit 16 may be processed to reduce the water concentration in the condensate before reintroducing the processed condensate with resulting reduced water concentration into the extractor. By generating different condensate streams having different alcohol and water concentrations as described herein, first condensate 30 may have a sufficiently high alcohol concentration and a sufficiently low water concentration to allow the condensate to be reused directly without dewatering. This can provide a processing and efficiency advantage as compared to generating a single condensate stream of greater volume but that requires dewatering before being recycled to extractor 12.

In the example of FIG. 1, extraction system 10 is illustrated as including a water removal unit 36 that receives second condensate 34 generated by second desolventizing unit 16. Water removal unit 36 can process the received second condensate 34 and separate water from the condensate, thereby increasing the alcohol concentration and the received second condensate stream for recycling back to extractor 12 and/or other use. For example, water removal unit 36 can separate water from the received second condensate 34 to generate a second condensate alcohol recovery stream 38 having an increased concentration of alcohol as compared to the second condensate 34 and separated water 40.

In different examples, water removal unit 36 may be implemented using one or more stages of a molecular sieve (mole sieve), one or more stages of a pervaporation system, and/or one or more stages of a vapor permeation membrane. In general, a molecular sieve utilizes a material with small pores sized to allow comparatively small molecules (e.g., water) to enter the back for entrapment while comparatively larger molecules (e.g., alcohol) are unable to pass into the molecular pores. The molecular sieve can be periodically regenerated, e.g., by heating and purging with a carrier gas or under vacuum, to remove the separated water 40 trapped in the sieve. By contrast, pervaporation generally involves a process of separating a mixtures of liquids by partial vaporization through a non-porous or porous membrane. The pervaporation process can proceed with initial permeation through a membrane by a permeate followed by evaporation into the vapor phase, generating a continuous stream of separated water 40 from the second condensate alcohol recovery stream 38.

If using certain water removal technologies, such as a mole sieve or vapor permeation membrane, the water can be removed from the solvent vapor prior to condensation. In these implementations, water removal unit 36 can be positioned between the desolventizing unit and condenser instead of downstream of the condenser, as illustrated in the example figure.

Independent of the configuration of water removal unit 36, the water removal unit may decrease the concentration of water in second condensate 34 by at least one weight percent based on the total weight of the second condensate, such as at least two weight percent, at least three weight percent, at least four weight percent, or at least five weight percent. For example, water removal unit 36 may decrease the concentration of water and second condensate 34 an amount within a range from two weight percent to 25 weight percent based on the total weight of second condensate 34, such as three weight percent to 15 weight percent, from three weight percent to 10 weight percent, or from three weight percent to seven weight percent.

After second condensate 34 is optionally processed through water removal unit 36 to generate second condensate alcohol recovery stream 38, the second condensate alcohol recovery stream may be recycled back to extractor 12. For example, second condensate alcohol recovery stream 38 may provide a recovered solvent that is recycled back to solvent inlet 24 of extractor 12 for reuse in the extraction of additional incoming solid material entering through feed inlet 20 of the extractor. In practice, streams described as being recycled back to extractor 12, such as first condensate 30 and second condensate alcohol recovery stream 38, may be supplied to one or more solvent tanks which, in turn, are drawn from to supply solvent inlet 24 of extractor 12 with incoming solvent.

In the example of FIG. 10, extraction system 10 is illustrated as being implemented with multiple different desolventizing units 14, 16 each configured to generate a different condensate stream 30, 34 having a different concentration of alcohol and water. In practice, the techniques of the present disclosure can be implemented using alternative configurations of extraction system 10 have a lesser number of desolventizing units (one desolventizing unit) or more desolventizing units (e.g., three, four, or more).

FIG. 2 is a block diagram illustrating another example extraction system 50 according to the disclosure in which a solvent-wetted extracted solid material is desolventized in a single desolventizing unit 52 to generate multiple condensate streams (first condensate 30, second condensate 34), albeit from a single vessel as opposed to using multiple vessels. In the example of FIG. 2, like reference numerals discussed above with respect to FIG. 1 refer to like components. Further, the example materials, compositions, and processing parameters (e.g., temperatures, pressures, alcohol concentration, water concentration) discussed above with respect to FIG. 1 also apply to system 50 of FIG. 2 unless otherwise specified.

System 50 in FIG. 2 includes previously described extractor 12 and a desolventizing unit 52. Unlike system 10 of FIG. 1 that includes a first desolventizing unit 14 and a second desolventizing unit 16, system 50 is illustrated as being implemented with a single desolventizing unit 52 (e.g., single vessel). In operation of the system of FIG. 2, solid material to be processed may be optionally dried by dryer 18 and supplied to extractor 12. Extractor 12 can discharge a solvent-wet extracted solid material via feed outlet 22 after the solid material has undergone extraction in the extractor and has a lower concentration of extract than the fresh incoming material. Extractor 12 can also discharge a miscella formed via extraction of extractable components from the solid material via solvent outlet 26.

The solvent-wetted extracted solid material discharged from extractor 12 via feed outlet 22 can be desolventized via desolventizing unit 52. Desolventizing unit 52 can vaporized solvent from the solvent-wetted extracted solid material supplied to the unit as the extracted solid material is conveyed through the unit (e.g., under a force of gravity and/or via mechanical conveyance). Desolventizing unit 52 can include multiple vapor discharge outlets/streams positioned at different locations along the desolventizing unit each configured to provide vapor generated from the solvent-wetted extracted solid material having a different concentration of alcohol and water.

For example, desolventizing unit 52 can receive the solvent-wetted extracted solid material via a feed inlet 54 and vaporize a portion of the solvent from the extracted solid material in the desolventizing unit 52, thereby generating the partially desolventized extracted material inside the unit. The partially desolventized extracted material can continue conveying through desolventizing unit 52, with further solvent vaporizing from the partially desolventized extracted material as the material continues to move through the desolventizing unit. This can generate a desolventized extracted material that discharged from a feed outlet 56 of the desolventizing unit.

Desolventizing unit 52 can include a first vapor outlet 58 through which solvent vaporized from the solvent-wetted extracted solid material can exit. Vapor discharging through the first vapor outlet 58 can be condensed in a condenser 52C1 operatively connected to the desolventizing unit to produce a first condensate stream 30. Desolventizing unit 52 can include a second vapor outlet 60 through which solvent vaporized from the partially desolventized extracted material can exit. Vapor discharging through the second vapor outlet 60 can be condensed in a condenser 52C2 operatively connected to the desolventizing unit to produce a second condensate stream 34. The first and second condensates 30, 34 can have compositions and be reused and/or further processed as discussed above with respect to extraction system 10 in FIG. 2.

Desolventizing unit 52 can be implemented using any suitable type of process equipment configured to perform the functions described herein. In some examples, desolventizer unit 52 is implemented as a desolventizer-toaster (DT), which may or may not dry and further “toast” or brown the outside surface of the solid material being processed, e.g., resulting in denaturing of protein present in the material being processed.

In some examples, desolventizer unit 52 includes a vessel containing a plurality of trays 62. The trays 62 can be arranged vertically relative to each other in a stacked arrangement with respect to gravity. While the illustrated example desolventizer has four trays, the desolventizer may be designed with fewer trays (e.g., two or three trays), or more trays (e.g., six, seven, or more) and the disclosure is not limited in this respect.

In operation, the material to be dried can enter the housing of the desolventizing unit 52 via feed inlet 54 and flow vertically downward through the desolventizer before exiting through feed outlet 56. As the material to be dried flows through the desolventizer, the material may flow over each of the respective trays in the desolventizer. The material may or may not physically contact the top surface of each of the trays, depending on whether the material flows on top of underlying material as it passes over a particular tray.

Each tray 62 can have one or more outlet openings that allows material to flow through the tray and down to an underlying tray or outlet 56 (e.g., after a desired of residence time on a particular tray). The one or more discharge ports can be located at any suitable location on the tray, for example, centered on the tray or offset to a side of the tray. A rotating sweep arm can be positioned on or a small distance above the top surface of each tray to mechanically sweep solid material being processed around the processing space defined by the tray. The rotating sweep arm can provide both a mixing function to intermix the solid material being processed with gas to promote desolventizing as well as a conveyance function to push solid material being processed from the opening of an upper tray to the outlet of the lower tray. For example, the rotating sweep arm may have blades bend or angled to direct material being pushed by the rotating sweep arm toward an opening located at a center of the tray.

The desolventizing unit 52 can heat and dry (by vaporizing solvent) the solvent wetted extracted solid material introduced into the device. A variety of different sources of direct and/or indirect heating may be used to supply thermal energy to the solid material being dried. For example, one or more (e.g., all) of trays 62 may provide indirect heating to the solid material being processed. Each such tray may have openings across its thickness that allows a thermal transfer fluid (e.g., steam) to pass through the tray and heat the tray without causing the thermal transfer fluid to enter into the space the solid material being dried flows through. Additionally or alternatively, one or more of trays 62 may provide direct heating, e.g., by having a steam sparge that injects steam up through the tray into the material being processed. The sidewalls of the vessel housing may or may not be heated.

For example, different trays of the desolventizer unit may be heated differently depending on their position within the desolventizer. The uppermost tray or trays (e.g., top two or three trays depending on vessel size) may be predesolventizing tray(s). These tray(s) may use indirect heat to flash vaporize solvent from the solvent wet solid material as the solvent wet solid material contacts the hot tray surface. However, the predesolventizing tray(s) may not have a direct heat source (e.g., steam sparge) to avoid adding additional moisture into the solvent wet solid material being processed in these trays.

The main or middle trays (e.g., middle-most one, two, three, four, or five trays depending on vessel size) may provide both indirect heating and direct steam contact to remove the bulk of the solvent from the solvent wet solid. This can also add moisture to the solvent wet solid, e.g., where is desired to steam cook the material, such as when processing residual solid from an oilseed feedstock. In different configurations, direct steam contact may be provided by having a steam distribution manifold under a tray and allowing steam to percolate up through the tray and/or by injecting steam as a mode of gas source above the tray. For example, some configurations of desolventizing unit 52 may include middle trays that are indirectly heated but do not have a direct heat source adding thermal energy under or through the tray. Rather, in these examples, direct heat (if optionally desired) may be supplied as a motive gas source that drives a recirculation loop of thermal energy in the space above the tray.

The lowermost tray or trays (e.g., bottom two or three trays depending on vessel size) may be a sparge tray. The sparging tray may be perforated for directs sparge steam injection, which can strip the final residual solvent from the solid material being processed and vent upwardly through desolventizer to second outlet 60. In other configurations, however, the lowermost tray or trays may not be sparge trays. For example, the lowermost tray or trays may provide indirect heating without any direct heat injection, or may even be unheated and/or cooled trays to cool the solid material before being discharged from the desolventizing unit. A variety of other configurations for desolventizing unit 52 can be used, and the disclosure is not limited to the foregoing example.

Extractor 12 in any of the foregoing examples can be implemented using any suitable type of extractor configuration. For example, extractor 12 may be an immersion extractor, a percolation extractor, or yet other type of extractor design. In one example, extractor 12 is a shallow bed continuous loop extractor.

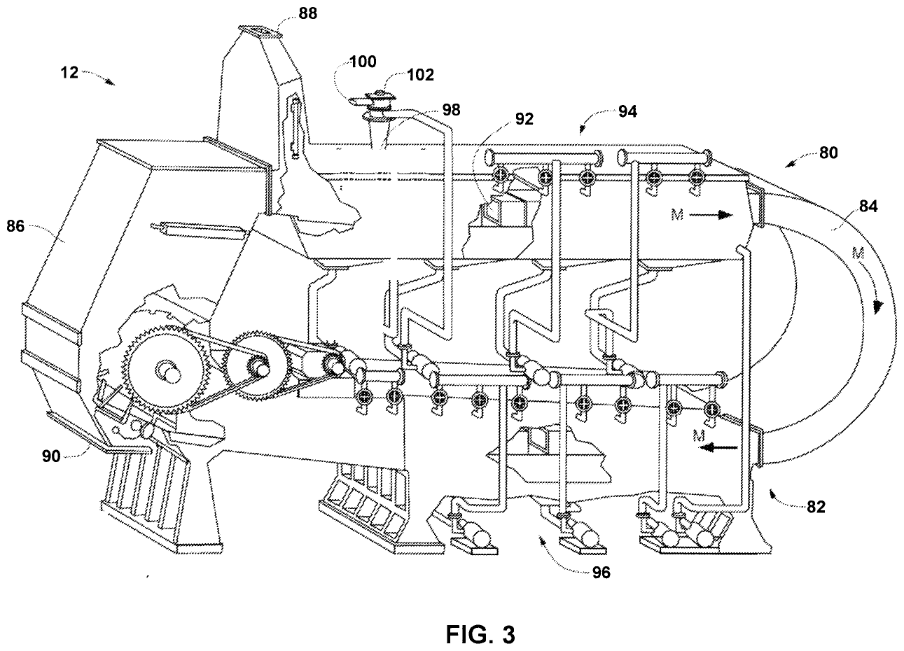

FIG. 3 is an illustration of an example extractor configuration that can be used for extractor 12. In the example shown, extractor 12 includes a housing defining a passageway in the form of a loop disposed in a vertical plane. The extractor can include upper and lower extraction sections 80, 82 each with a series of extraction chambers, a generally arcuate hollow transfer section 84 having its opposite upper and lower ends connected to first ends of the upper and lower extraction sections respectively, and a hollow, generally vertical return section 86 connected at its upper and lower ends respectively to the other ends of the upper and lower extraction sections. The upper extraction section can include an inlet portion 88 for delivery of solid material to the interior thereof in closely spaced relation to the upper end of the return section, and the lower end of the return section can define an opening 90 for discharge of the material after the product-of-interest has been extracted therefrom. The number of extraction chambers, or stages, provided by the extractor can vary depending on the desired sized of the extractor. The extractor includes at least one extraction chamber, or stage, and typically includes multiple stages (e.g., 6 stages, 8 stages, or more). A Model III extractor commercially available from Crown Iron Works Company of Minneapolis, MN, is a specific example of an extractor of this type.

In such an extractor, a conveyor system 92 can extend longitudinally through the looped passageway and be driven in a material flow direction “M” to move the material as a bed from the inlet portion 88 through the upper extraction section 80 toward and downwardly through the transfer section 84, and through the lower extraction section 82 toward the lower end of the return section and the discharge opening 90. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 94 can be disposed above the solid materials and configured to apply a fluid to the solid materials in each extraction chamber, and a fluid removal system 96 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 3, fluid having passed through the solid material is collected by the fluid removal system 96 and delivered to a separation device 98, which in the illustrated example is shown as a cyclone-type separator to separate any solid fines from the fluid before fluid discharge. An outlet conduit 100 of separation device 98 can deliver the fluid, generally a mixture of extraction fluid and soluble components extracted from the solid material into the extraction fluid (e.g., oil when processing oil seed) (commonly known as “miscella”), to other equipment, not shown, for separating the extraction fluid from the material extracted from the solid material being processed. A separate outlet 102 of separation device 98 can deliver a stream containing particulate matter separated from the miscella for further processing, as described herein.

As material is conveyed through extractor 12, spray headers from the fluid supply system 94 spray recycled extraction fluid on the top of the material. The material percolates through the material and through the screen, where it is collected in the network of drain pipes and delivered back to the network of spray headers where it is reapplied to the solid material in a different extraction chamber. In some embodiments, fresh extraction fluid is applied to the material in the last extraction chamber before the solid material discharge 90. For example, fresh extraction fluid—which may be or include recovered solvent from one or more desolventizers as discussed herein—may be applied to the material in the last extraction chamber before discharge 90 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 90 and an enriched extraction fluid outlet adjacent inlet 88, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 88 to a comparatively low concentration at the outlet 90.

An alcohol-based solvent extraction process according to the present disclosure may provide various advantages over an extraction process that does not use an alcohol-based solvent. For example, an alcohol-based solvent may provide better compatibility with food supply chains. Ethanol is GRAS (Generally Recognized As Safe), can be produced organically from renewable feedstocks, and is already consumed directly as a component of alcoholic beverages. As another example, an alcohol-based solvent may improve the processed product attributes of some feedstocks. When applied to soybean flakes, for instance, an alcohol-based solvent may produce a meal with less “beany” flavor and less color. When applied to either soybean flakes or cottonseed meats, an alcohol-based solvent may alter protein solubility and lower antinutritional factor content. The alcohol-based solvent may produce an oil with lower wax and phosphatide content.

The following example may provide additional details about extraction and desolventization systems and techniques according to the disclosure.

### Example

An experiment was conducted studying the composition of the liquid vaporized from an example solvent-wetted extracted material over time during desolventization. The material used for the experiment was defatted soy flakes generated during a prior extraction run that were dried and stored in a sealed container. A solvent mixture of ethanol and water was prepared, and the defatted soy flakes were immersed in the solvent for a period of time adequate to equilibrate. After the equilibration period, the flakes were drained using a screen similar to the drainage screen used on the Crown Model III extractor. The water content of the drained solvent was then measured via mass balance to determine the mass of solvent in the flakes prior to desolventization.

An experimental desolventization apparatus was then used to desolventize the solvent-wetted extracted flakes. The experimental apparatus utilized a heated bath of water/oil in which a closed desolventizing vessel was placed. An agitator was positioned in the desolventizing vessel to stir the flakes inside of the desolventizing vessel during desolventization. In addition, a condenser was positioned to condense solvent evaporated through a vent port of the desolventizing vessel. A pump was also provided to recirculate motive air through the desolventizing vessel via corresponding ports. The desolventization apparatus was operated at atmospheric pressure. A first run was conducted using an applied surface temperature (to the desolventization vessel) of 120 degrees Celsius. A second run was conducted using an applied surface temperature (to the desolventization vessel) of 83 degrees Celsius. In each case, the solvent-wetted extracted material was desolventized for an amount of time until the condensate appeared to stop significantly flowing based on visual observation (less than 10 drops over 15-20 minutes).

The condensate from the apparatus was fractionally collected and the corresponding water content of each sample measured. The mass of solvent in each sample was also measured. Using that data along with a post-desolventization weighing of the desolventized flakes, and attributing for losses from evaporation and glassware liquid film, the flake ethanol was calculated.

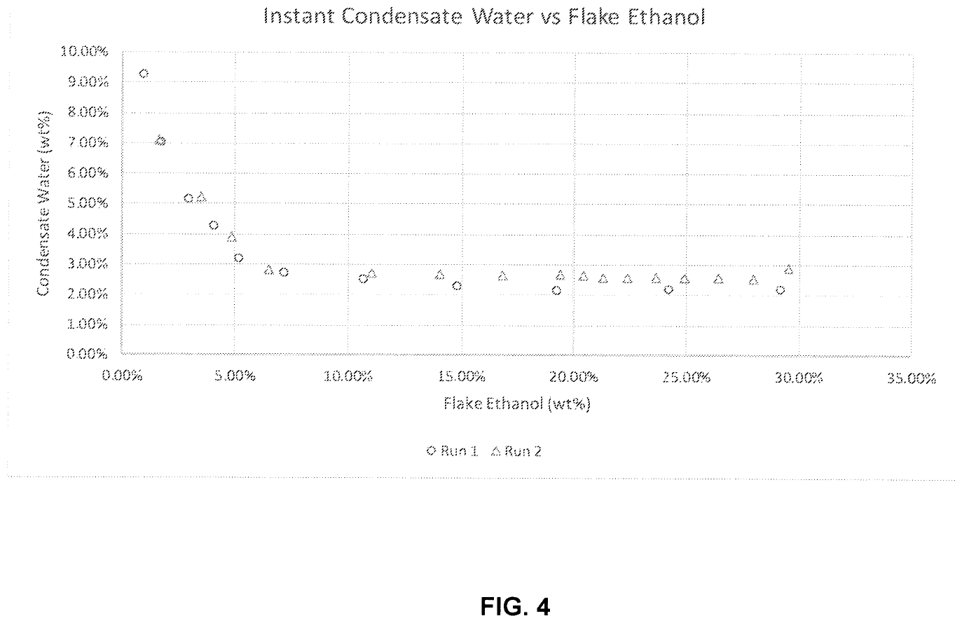

FIG. 4 is a plot of the concentration of water in the condensate produced by the desolventization apparatus on the Y-axis relative to the concentration of ethanol in the flake during drying on the X-axis. The water concentration is presented as a weight percentage based on the total weight of the condensate (with the corresponding ethanol concentration being 100% minus the reported water concentration). The ethanol concentration in the flake is presented as a weight percentage of ethanol based on the total weight of the solvent-wetted material being desolventized (weight of flake, ethanol, and water) during drying. Data from two different runs are presented on FIG. 4.

As illustrated, the concentration of water in the condensate produced during desolventization remained at a substantially constant level of approximately 2 wt % (e.g., 1.5 to 4 wt %) as the solvent-wetted material being desolventized was dried from an alcohol concentration level of approximately 30 wt % down to an alcohol concentration level of approximately 5 wt % (e.g., 4 to 6 wt %). At an alcohol concentration level of approximately 5 wt %, the concentration of water in the condensate spiked by multiples of what was previously observed.

1. A method comprising:
extracting a material to be processed with a solvent comprising alcohol in an extractor to generate an extracted material stream and a miscella stream, the extracted material stream comprising extracted solid material wetted with liquid comprising alcohol and water;
desolventizing the extracted material stream down to a first alcohol level thereby generating a partially desolventized extracted material and a first condensate, wherein the first condensate comprises water and the alcohol;
desolventizing the partially desolventized extracted material down to a second alcohol level less than the first alcohol level thereby generating a desolventized extracted material and a second condensate, wherein the second condensate comprises water and the alcohol, and a weight fraction of water in the second condensate is greater than a weight fraction of water in the first condensate.

2. The method of claim 1, wherein desolventizing the extracted material stream down to the first alcohol level and desolventizing the partially desolventized extracted material down to the second alcohol level comprises desolventizing the extracted material stream down to the first alcohol level and desolventizing the partially desolventized extracted material down to the second alcohol level in a single desolventizing vessel.

3. The method of claim 2, wherein desolventizing the extracted material stream down to the first alcohol level and desolventizing the partially desolventized extracted material down to the second alcohol level in the single desolventizing vessel comprises:
conveying the extracted material stream through the single desolventizing vessel and heating the extracted material stream as the extracted material stream is conveyed through the single desolventizing vessel;
drawing a first vapor stream off the single desolventizing vessel and condensing the first vapor stream in a first condenser to form the first condensate; and
drawing a second vapor stream off the single desolventizing vessel and condensing the second vapor stream in a second condenser to form the second condensate.

4. The method of claim 3, wherein:
conveying the extracted material stream through the single desolventizing vessel and heating the extracted material stream as the extracted material stream is conveyed through the single desolventizing vessel comprises progressively desolventizing the extracted material stream through the single desolventizing vessel;
the partially desolventized extracted material is defined by the extracted material stream in the single desolventizing vessel downstream of a draw location of the first vapor stream; and
the desolventized extracted material is a discharge product from the single desolventizing vessel.

5. The method of claim 1, wherein:
desolventizing the extracted material stream down to the first alcohol level comprises desolventizing the extracted material stream in a first desolventizing vessel; and
desolventizing the partially desolventized extracted material comprises desolventizing the partially desolventized extracted material in a second desolventizing vessel different than the first desolventizing vessel.

6. The method of claim 5, wherein:
desolventizing the extracted material stream in the first desolventizing vessel comprises conveying the extracted material stream from the extractor to the first desolventizing vessel and vaporizing solvent from the extracted material stream in the first desolventizing vessel under a first set of vaporization conditions; and
desolventizing the partially extracted material in the second desolventizing vessel comprises conveying the partially extracted material from the first desolventizing vessel to the second desolventizing vessel and vaporizing solvent from the partially extracted material in the second desolventizing vessel under a second set of vaporization conditions.

7. The method of claim 6, wherein the first set of vaporization conditions are different than the second set of vaporization conditions in one or more of temperature, pressure, and added stream.

8. The method of claim 5, wherein:
desolventizing the extracted material stream in the first desolventizing vessel comprises desolventizing the extracted material stream in the first desolventizing vessel without injecting steam into the first desolventizing vessel; and
desolventizing the partially extracted material in the second desolventizing vessel comprises introducing steam into the second desolventizing vessel.

9. The method of claim 5, wherein:
the first desolventizing vessel is selected from the group consisting of a rotary disk dryer, a desolventizer-toaster, a down-draft desolventizer, a flash dryer, and combinations thereof; and
the second desolventizing vessel is selected from the group consisting of a desolventizer-toaster, a down-draft desolventizer, a flash dryer, and combinations thereof.

10. The method of claim 1, wherein the extractor comprises a solvent inlet, and further comprising recycling the first condensate back to the solvent inlet without performing further processing to remove water from the first condensate.

11. The method of claim 1, further comprising processing the second condensate to separate the alcohol in the second condensate from water in the second condensate, thereby forming a second condensate alcohol recovery stream.

12. The method of claim 11, wherein processing the second condensate to separate the alcohol in the second condensate from water in the second condensate comprises processing the second condensate in a molecular sieve and/or a pervaporation system.

13. The method of claim 11, further comprising recycling the second condensate alcohol recovery stream to a fresh solvent inlet of the extractor.

14. The method of claim 1, wherein the first alcohol level is a value less than 12 wt % of the weight of the partially desolventized extracted material and greater than 3 wt % weight of the partially desolventized extracted material, and the first condensate stream comprises greater than 90 wt % alcohol and less than 10 wt % water.

15. The method of claim 1, wherein the second condensate stream comprises greater than 75 wt % alcohol and from 2 wt % to 25 wt % water.

16. The method of claim 1, wherein a difference in a weight fraction of water in the second condensate minus the weight fraction of water in the first condensate is a value within a range from 3% to 5%.

17. The method of claim 1, wherein the extracted material stream from the extractor prior to desolventizing comprises from 30 wt % to 50 wt % solvent based on a total weight of the extracted material stream, such as from 35 wt % to 45 wt % solvent.

18. The method of claim 1, wherein the alcohol comprises ethanol.

19. An extractor system comprising:
an extractor having a feed inlet configured to receive a material to be processed and a solvent inlet configured to receive a solvent comprising alcohol, the extractor being configured to intermix the material to be processed with the solvent within an extraction chamber thereby producing a miscella stream and an extracted material stream comprising extracted solid material wetted with liquid comprising alcohol and water; and
at least one desolventizer configured to:
receive the extracted material stream from the extractor;
desolventize the extracted material stream down to a first alcohol level thereby generating a partially desolventized extracted material and a first vapor stream; and
desolventize the partially desolventized extracted material down to a second alcohol level less than the first alcohol level thereby generating a desolventized extracted material and a second vapor stream, wherein a weight fraction of water in the second vapor stream is greater than a weight fraction of water in the first vapor stream.

20. The system of claim 19, further comprising at least one condenser configured to:
receive the first vapor stream and condense the first vapor stream to generate a first condensate, wherein the first condensate comprises water and the alcohol; and
receive the second vapor stream and condense the second vapor stream to generate a second condensate, wherein the second condensate comprises water and the alcohol, wherein and the weight fraction of water in the second condensate is greater than a weight fraction of water in the first condensate.

21. The system of claim 20, further comprising a water removal unit configured to receive the second condensate and to separate the alcohol in the second condensate from water in the second condensate, thereby forming a second condensate alcohol recovery stream.

22. The system of claim 21, wherein the first condensate and the second condensate alcohol recovery stream are recycled back to the solvent inlet of the extractor.

23. The system of claim 19, wherein the at least one desolventizer is a single desolventizing vessel comprising:
an inlet configured to receive the extracted material stream from the extractor;
an outlet configured to discharge the desolventized extracted material;
a first vapor outlet configured to discharge the first vapor stream; and
a second vapor outlet downstream of the first vapor outlet in a direction of solid material flow configured to discharge the second vapor stream.

24. The system of claim 19, wherein the at least one desolventizer comprises:
a first desolventizing vessel configured to receive the extracted material stream from the extractor, desolventize the extracted material stream down to the first alcohol level, and discharge the partially desolventized extracted material; and
a second desolventizing vessel configured to receive the partially desolventized extracted material from the first desolventizing vessel, desolventize the partially desolventized extracted material down to the second alcohol level, and discharge desolventized extracted material.
